(19) United States
(12) Patent Application Publication
(10) Pub. No.: US 2025/0231552 A1
(43) Pub. Date: Jul. 17, 2025

(54) COMPUTER-SUPPORTED MANUFACTURING METHOD, AND MANUFACTURING SYSTEM

(71) Applicant: TRUMPF Werkzeugmaschinen SE + Co. KG, Ditzingen (DE)

(72) Inventors: Frederick Struckmeier, Heimsheim (DE); Korbinian Weiß, Korntal (DE); Jens Ottnad, Karlsruhe (DE)

(21) Appl. No.: 19/171,406

(22) Filed: Apr. 7, 2025

Related U.S. Application Data
(63) Continuation of application No. PCT/EP2023/077000, filed on Sep. 29, 2023.

(30) Foreign Application Priority Data
Oct. 7, 2022 (DE) 10 2022 125 984.6

(51) Int. Cl. G05B 19/418

(52) U.S. Cl. CPC G05B 19/41865; G05B 2219/31053; G05B 2219/32368

(57) ABSTRACT

A computer-supported manufacturing method for manufacturing workpieces from a workpiece blank according to a manufacturing plan using a machine tool including a processing device. The method includes manufacturing at least one workpiece using the machine tool. A defective workpiece is identified. Manufacturing information related to the identified defective workpiece is read by an order control device. The method ascertains a workpiece blank which is suitable for remanufacturing the faulty workpiece in a planned manufacturing sequence on the basis of the read manufacturing information by the order control device. The defective workpiece to be remanufactured is arranged on the ascertained workpiece blank by the order control device.

### CROSS REFERENCE TO RELATED APPLICATIONS

This application is a continuation of International Application No. PCT/EP2023/077000 (WO 2024/074411 A1), filed on Sep. 29, 2023, and claims benefit to German Patent Application No. DE 10 2022 125 984.6, filed on Oct. 7, 2022. The aforementioned applications are hereby incorporated by reference herein.

### FIELD

The disclosure relates to a computer-supported manufacturing method for manufacturing workpieces from a workpiece blank by a machine tool according to a planned manufacturing sequence. Furthermore, the disclosure relates to a manufacturing system for carrying out the manufacturing method.

### BACKGROUND

Such methods are typically used in the processing of workpiece blanks in the form of sheet metal, which can be fed to the machine tool as sheet metal panels or sheet metal rolls. In addition, such processes can be used in the processing of materials. Cutting machines, especially laser cutting machines, and/or punching machines are often used to process the workpiece blanks.

During laser cutting, a variety of influences can lead to a workpiece being damaged during manufacturing or being made incorrectly by the machine tool. Such damaged or defective workpieces can be detected by the machine tool or the operator, and must then be remanufactured to fully complete a manufacturing order.

Typically, defective or damaged workpieces are remanufactured by an operator, usually manually and at great expense. For the remanufacture of individual workpieces, it is often necessary to resort to unused workpiece blanks, which, however, can then no longer be fed into the regular manufacturing method. The remanufacture of these defective or damaged workpieces therefore leads to considerable additional costs and considerable material waste.

To prevent delays, it is often planned that individual or all workpieces of a manufacturing order are manufactured twice or multiple times. In other words, reserve workpieces are produced to replace defective and/or damaged workpieces if needed. Unused reserve workpieces must then be disposed of. This leads to considerable material waste and a significantly longer manufacturing time and therefore does not represent an adequate solution to the problems described above.

### SUMMARY

In an embodiment, the present disclosure provides a computer-supported manufacturing method for manufacturing workpieces from a workpiece blank according to a manufacturing plan using a machine tool, including a processing device, and having the method steps of: manufacturing at least one workpiece using the machine tool; identifying a defective workpiece; reading of manufacturing information on the identified defective workpiece by an order control device; ascertaining a workpiece blank suitable for remanufacturing the defective workpiece in a planned manufacturing sequence based on the manufacturing information read by the order control device; and arranging the defective workpiece to be remanufactured on the ascertained workpiece blank by the order control device.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic representation of a manufacturing method, according to an embodiment of the present disclosure, for manufacturing a workpiece;

FIG. 2 shows a schematic representation of a manufacturing system having a processing device and an order control device for carrying out an exemplary embodiment of the manufacturing method, according to an embodiment of the present disclosure, according to FIG. 1; and

FIG. 3 shows a schematic representation of a computer-supported manufacturing method 10 according to an embodiment of the present disclosure.

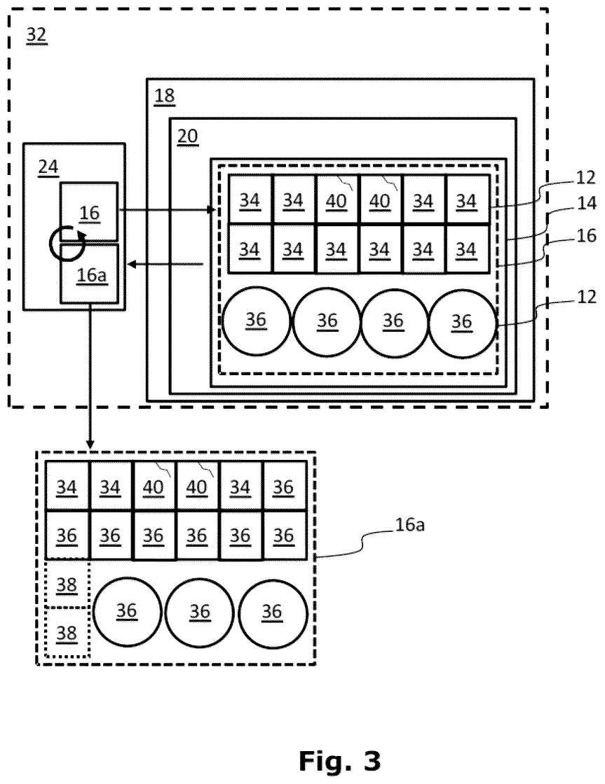

### DETAILED DESCRIPTION

In accordance with an embodiment, the present disclosure provides a method for operating a processing device with which high manufacturing costs and high material waste caused by the remanufacture of defective and/or damaged workpieces can be avoided. Furthermore, the task is to specify an appropriate manufacturing system.

In accordance with another embodiment, the present disclosure provides a computer-supported method. In accordance with another embodiment, the present disclosure provides a manufacturing method.

According to another embodiment of the present disclosure, a computer-supported manufacturing method is provided.

The manufacturing method is suitable for manufacturing workpieces from a workpiece blank. A workpiece blank can be in the form of a sheet product, for example in the form of a sheet of metal, and/or in the form of a rolled product, for example in the form of a roll of sheet metal or a roll of fabric.

The method provides for the use of a machine tool, in particular a flat-bed machine tool, with a processing device. The processing device can be designed, for example, as a cutting machine or punching machine.

The workpieces are manufactured from the workpiece blank by the machine tool according to a manufacturing plan. The manufacturing plan includes at least one workpiece to be manufactured. Preferably, the manufacturing plan comprises several, particularly preferably a large number of, workpieces to be manufactured. The manufacturing plan can have a workpiece grouping with several related workpieces, for example a common assembly. In such cases, the process characteristics described here and below can also refer to workpiece groupings. The manufacturing plan can contain workpieces and/or workpiece groupings from different manufacturing orders.

The manufacturing plan typically contains geometric manufacturing data on the workpieces to be manufactured, for example one or more workpiece dimensions, in particular the workpiece thickness, a workpiece material, a workpiece contour and/or a workpiece position on the workpiece blank. The manufacturing information is preferably coded in a machine-readable manner and contains all relevant information that enables the workpieces to be manufactured, in particular automatically. In other words, manual handling by an operator is no longer necessary.

In a further method step, at least one workpiece is manufactured from the workpiece blank according to the manufacturing plan. In other words, the machine tool begins manufacturing the workpieces. For example, a laser cutting machine can begin cutting workpieces to be manufactured from the workpiece blank according to the manufacturing plan.

In a further method step, a defective workpiece is identified or detected. A defective workpiece can be understood, for example, as a workpiece that has been manufactured incorrectly by the processing device, in particular using manufacturing parameters that deviate from the manufacturing plan. Furthermore, a defective workpiece can have been caused by damage to the workpiece during the manufacture of the workpiece and/or during the manufacture of subsequent workpieces. Damage can occur, for example, through a collision between the processing device and the workpiece.

The defective workpiece can be identified or detected during manufacture and/or in the manufactured state. Identifying the defective workpiece means detecting it through workpiece inspection. The identification can be done by an operator. Preferably, the defective workpiece is identified by a control device on the machine tool. Particularly preferably, the identification is carried out automatically by regular or permanent monitoring of the manufacture of the workpieces in the machine tool. A defective workpiece can be detected, for example, by deviations from manufacturing parameters, in particular machine parameters, during the manufacture of the workpiece. Furthermore, for example, a defective workpiece can be detected by reporting a collision between the processing device and the workpiece and/or by optically comparing the workpiece with the target state of the workpiece according to the manufacturing plan. A target state of the workpiece can further refer, for example, to the workpiece dimensions, the workpiece shape and/or an edge quality.

In a further method step, manufacturing information on the identified defective workpiece is read by an order control device. For this purpose, the identified defective workpiece can first be reported to the order control device. A message can be sent by entering the defective workpiece into the order control device. Preferably, the order control device is set up for data exchange with the control device designed to identify the defective workpiece, whereby an automatic report of the defective workpiece can be made. The order control device then reads the manufacturing-relevant information, in particular a workpiece thickness, a workpiece shape, and a workpiece material, for the defective workpiece. Typically, the order control device reads the manufacturing information from the manufacturing plan. From the manufacturing information, manufacturing requirements for a workpiece blank to be used can be derived through the order control device. The workpiece blank to be used is typically similar or identical to the workpiece blank from which the defective workpiece is manufactured.

In a further method step, the order control device ascertains a workpiece blank suitable for remanufacturing the defective workpiece in a planned manufacturing sequence depending on the manufacturing information read.

The planned manufacturing sequence is understood to mean the manufacture of workpieces according to a further manufacturing plan following the manufacture of the workpieces according to the manufacturing plan. In other words, the manufacturing sequence provides for the further manufacture of workpieces as planned from further workpiece blanks.

The manufacturing sequence can include the further manufacture of workpieces from further workpiece blanks by the processing device and/or the further manufacture of workpieces from further workpiece blanks by at least one further machine tool with a further processing device. In other words, the manufacturing sequence can include the manufacture of workpieces in additional machine tools using additional processing devices.

The order control device is preferably designed and set up to manage the manufacturing sequence. The order control device is set up in particular for creating, reading and/or changing manufacturing plans in the manufacturing sequence. The order control device can be designed as a central control for managing manufacturing plans of different machine tools.

To ascertain the suitable workpiece blank, the order control device can first read the blank information underlying the manufacturing plans in the planned manufacturing sequence of the workpiece blanks to be used in the manufacture of the workpieces. Typically, the order control device then compares the blank information with the manufacturing information of the workpiece to be remanufactured. A workpiece blank can be ascertained to be suitable if the workpiece blank meets the manufacturing requirements derived from the manufacturing information of the workpiece to be remanufactured.

In a subsequent method step, the workpiece to be remanufactured is arranged on the suitable workpiece blank by the order control device. In other words, the order control device can change the manufacturing plan of the workpiece blank ascertained to be suitable in such a way that the workpiece to be remanufactured is manufactured by a processing device when the manufacturing plan is executed.

According to the disclosure, a computer-supported manufacturing method is thus provided in which a defective workpiece is remanufactured, preferably automatically, by the order control device in the planned manufacturing sequence. Manual remanufacturing of the defective workpiece is thus no longer necessary. Furthermore, a workpiece blank can be used for remanufacturing, which is provided for the manufacture of workpieces. This helps keep material waste to a minimum.

In a preferred embodiment of the computer-supported manufacturing method, the manufacturing information includes a manufacturing end time for the workpiece to be remanufactured. In this case, a workpiece blank can be ascertained to be suitable if the machining of the workpiece blank by the processing device takes place in the manufacturing sequence before the manufacturing end time. In other words, it can be checked whether remanufacturing the defective workpiece would lead to a delay in the delivery date. This allows measures to be taken to remanufacture the workpiece more quickly, for example by manual remanufacture.

The order control device is preferably set up to automatically carry out measures for more urgent remanufacturing. This can further increase the degree of autonomy of the manufacturing method.

Further preferred is an embodiment of the computer-supported manufacturing method in which the manufacturing information comprises at least one workpiece dimension. The workpiece blank can be ascertained as suitable by the order control device if the workpiece to be remanufactured can be arranged on the workpiece blank, in particular in a free space between planned workpieces to be manufactured. In other words, the order control device is set up to ascertain free spaces in the manufacturing plans of the planned manufacturing sequence. By arranging the workpiece to be remanufactured in a free space in the manufacturing plan, a higher workpiece density on the workpiece blank and thus a particularly resource-saving remanufacture can be made possible.

In a preferred further development of the computer-supported manufacturing method, planned workpieces to be manufactured are rearranged to arrange the workpiece to be remanufactured on the workpiece blank. In other words, the manufacturing sequence is subjected to a plan optimization by the order control device, taking into account the workpiece to be remanufactured. Plan optimization can, for example, be carried out by rearranging the workpieces to be manufactured with reduced spacing and/or by nesting the workpieces together on the workpiece blank to save space.

Furthermore, a further development of the computer-supported manufacturing method is preferred in which, to arrange the workpiece to be remanufactured on the workpiece blank, planned workpieces to be manufactured are arranged on a workpiece blank following the workpiece blank. In other words, it can be provided that a prioritization of the workpiece to be remanufactured, for example on the basis of the manufacturing end time, takes place by postponing subsequent manufacturing orders. This allows for a more urgent remanufacture of the workpiece. For example, the manufacturing end time can be met by prioritizing the workpiece to be remanufactured. Preferably, the prioritization of a workpiece to be remanufactured only takes place if the prioritization allows the subsequent workpieces to be manufactured up to their manufacturing end time.

In a preferred embodiment of the computer-supported manufacturing method, it is provided that the workpiece to be remanufactured, arranged on the suitable workpiece blank, is manufactured by the processing device. Preferably, the at least one remanufactured workpiece is checked in accordance with the previous explanations, in particular with regard to the method step “identifying the defective workpiece” with regard to error-free production. If the remanufactured workpiece is again identified as defective, the procedure described above can be carried out again. Furthermore, an operator can be notified, allowing detailed troubleshooting to be carried out.

In a preferred embodiment of the computer-supported manufacturing method, the machine tool is designed as a laser cutting machine. The application of the manufacturing method in conjunction with a laser cutting machine was found to be particularly advantageous by the inventors.

According to an alternate embodiment, the present disclosure provides a manufacturing system.

The manufacturing system comprises at least one processing device and the order control device. Preferably, the manufacturing system comprises several processing devices. The processing devices are typically each assigned to a machine tool. The order control device can be designed to be implemented by one or more machine tools. Preferably, the order control device is designed as a separate unit of the manufacturing system. In any case, the order control device is set up to communicate with at least one, in particular with all, processing devices.

The manufacturing system is configured to perform the manufacturing method described above and below.

According to the disclosure, the features mentioned above and those yet to be explained further can be used in each case individually or together in any desired expedient combinations. The embodiments shown and described should not be understood as an exhaustive list, but rather are of an exemplary character for describing the disclosure.

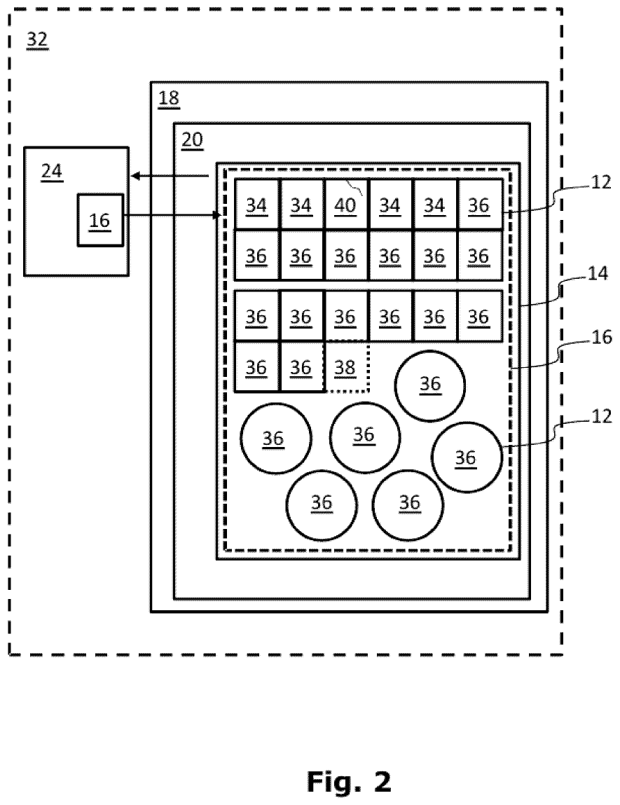

The manufacturing method 10 is designed for manufacturing workpieces 12 (see FIG. 2) from a workpiece blank 14 (see FIG. 2) according to a manufacturing plan 16 (see FIG. 2) by a machine tool 18 (see FIG. 2), especially a flat-bed machine tool, having a processing device 20 (see FIG. 2).

The manufacturing method 10 comprises the following method steps:
a) Manufacturing 22 at least one workpiece 12 by the machine tool 18;
b) Identifying 24 a defective workpiece 26;
c) Reading 28 of manufacturing information on the identified defective workpiece 26 by an order control device 30;
d) Ascertaining 32 a workpiece blank suitable for remanufacturing the defective workpiece 26 34 (see FIG. 2) in a planned manufacturing sequence 36 (see FIG. 2) depending on the manufacturing information read by the order control device 30;
e) Arranging 38 a workpiece to be remanufactured 40 on the suitable workpiece blank 34 by the order control device 30.

In a subsequent method step, the workpiece 38 to be remanufactured can be manufactured by the processing device 20.

FIG. 2 shows a schematic representation of a manufacturing system 42.

The manufacturing system 42 comprises the processing device 20 and the order control device 30. The processing device 20 is part of the machine tool 18, which is designed to manufacture workpieces 12 from the workpiece blank 14 according to the manufacturing plan 16. For reasons of clarity, only two workpieces 12 are provided with a reference symbol. According to the embodiment shown, the order control device 24 is designed as a separate unit and is configured to be in communication with the processing device 20.

In a particular embodiment, it can be provided that the manufacturing system 42 has at least two, in particular several, machine tools 18, each having a processing device 20.

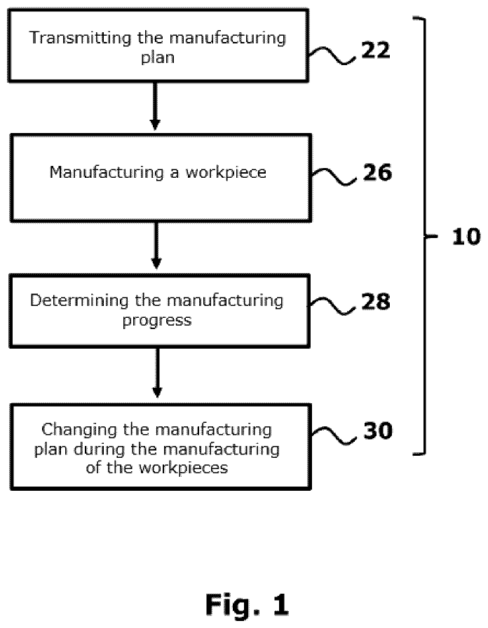

In the following, the manufacturing method 10 (see FIG. 1) is explained in more detail using the illustrated manufacturing system 42.

According to method step 22 (see FIG. 1), “Manufacturing at least one workpiece”, at least one workpiece 12 is manufactured by the processing device 20 of the machine tool 18 based on the manufacturing plan 16. The manufacturing plan 16 was typically transmitted to the processing device 20 by the order control device 30 prior to manufacture 22. As shown, several workpieces 12 were manufactured by the processing device 20 and are available as manufactured workpieces 44.

Furthermore, according to FIG. 2, several of the workpieces 12 to be manufactured are available as unfinished workpieces 46. In other words, the illustration in FIG. 2 shows a current state during the manufacture of the workpieces 12.

According to a further method step 24 (see FIG. 1), “Identifying a defective workpiece”, a damaged and/or defective workpiece 26 that was incorrectly manufactured by the processing device 20 is identified. The identification or detection of the defective workpiece 26 can, as shown, take place during the manufacture 22 of the workpieces 12. In particular, it can be provided that a defective workpiece 26 is already detected as such during the manufacturing 22 of the defective workpiece 26.

For identification purposes, the manufacturing system 42, in particular the machine tool 18 and/or the order control device 30, can have control means (not shown in detail), which, for example, detect irregularities during the manufacture 22 of the workpieces 12 on the processing device 20 and/or compare workpieces 44 manufactured by optical evaluation devices with a target state which can be derived from the manufacturing plan 16. In other words, the defective workpiece 26 as such can be assigned to a workpiece 12 that is actually to be manufactured in the manufacturing plan 16 and can be ascertained as defective via deviations.

The information about the defective workpiece 26 and/or about the workpiece 12 actually to be manufactured can be reported to the order control device 30, preferably a comparison unit 50 of the order control device 30.

In a further method step 28 (see FIG. 1), “Reading manufacturing information”, the order control device 30, preferably the comparison unit 50, reads out the manufacturing information on the defective workpiece 26 or on the workpiece 12 actually to be manufactured. Typically, the order control device 30 reads the manufacturing information from the manufacturing plan 16 as shown.

According to a further method step 30 (see FIG. 1), “Ascertaining a suitable workpiece blank”, the order control device 30 ascertains a workpiece blank 34 suitable for remanufacturing the defective workpiece 26 in a planned manufacturing sequence.

For this purpose, it can be provided that the order control device 30, in particular the comparison unit 50 as shown, derives blank requirements from the read manufacturing information for the workpiece 40 to be remanufactured. Typically, a suitable workpiece blank 34 may, for example, have the same material and the same blank thickness as the workpiece blank 14 actually intended for manufacturing the defective workpiece 26.

The manufacturing sequence can have one, as shown two, further manufacturing plans 16a, 16b. The manufacturing plans 16a, 16b are for example for the manufacture of workpieces 12a, 12b from workpiece blanks 14a, 14b following the processing of the manufacturing plan 16 by the processing device 20. The manufacturing plans 16a, 16b are preferably managed by the order control device 30. In other words, the manufacturing plans 16a, 16b can be changed by the order control device 30, in particular by the comparison unit 50.

In the example shown, both the manufacturing plan 16a and the manufacturing plan 16b of the manufacturing sequence 36 have free spaces 52. According to the example, the clearances 52 are sufficiently dimensioned to remanufacture the defective workpiece 26 either according to the manufacturing plan 16a from the workpiece blank 14a, or according to the manufacturing plan 16b from the workpiece blank 14b. In other words, blank requirements regarding the dimensions of a clearance 50 needed for remanufacturing the defective workpiece 26 can be met.

The workpiece blank 14a can have a blank thickness that is, for example, less than or greater than the blank thickness of the workpiece blank 14. Alternatively or additionally, the workpiece blank 14a can have a different blank material compared to the original workpiece blank 14. In other words, the blank requirements regarding a blank thickness and/or a blank material cannot be met.

In this case, the order control device 30 can provide that the blank requirements are compared with the next workpiece blank 14b in the manufacturing sequence. The workpiece blank 14b, for example, can meet all blank requirements. The workpiece blank 14b is then ascertained by the order control device 30 as a suitable workpiece blank 34.

According to a further method step 38 (see FIG. 1), “Arranging the workpiece to be remanufactured on the workpiece blank”, the workpiece 12 to be remanufactured is arranged on the workpiece blank 14b. In other words, the manufacturing plan 16b is changed by the order control device 30 so that it includes the remanufacturing of the defective workpiece 26 together with the manufacturing of the workpieces 12b.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

Manufacturing method 10;
Workpiece 12, 12a, 12b;
Workpiece blank 14, 14a, 14b;
Manufacturing plan 16, 16a, 16b;
Machine tool 18;
Processing device 20;
Method step 22, “Manufacturing a workpiece”
Method step 24, “Identifying a defective workpiece”;
Defective workpiece 26;
Method step 28, “Reading of manufacturing information”;
Order control device 30;
Method step 32, “Ascertaining a suitable workpiece blank”;
Suitable workpiece blank 34;
Manufacturing sequence 36;
Method step 38, “Arranging a workpiece to be remanufactured on the appropriate workpiece blank”;
Workpiece to be remanufactured 40;
Manufacturing system 42;
Manufactured workpieces 44;
Unfinished workpiece 46;
Comparison unit 50;
Open space 52.

1. A computer-supported manufacturing method for manufacturing workpieces from a workpiece blank according to a manufacturing plan using a machine tool, comprising a processing device, and having the method steps of:
a) manufacturing at least one workpiece using the machine tool;
b) identifying a defective workpiece;
c) reading of manufacturing information on the identified defective workpiece by an order control device;
d) ascertaining a workpiece blank suitable for remanufacturing the defective workpiece in a planned manufacturing sequence based on the manufacturing information read by the order control device; and
e) arranging the defective workpiece to be remanufactured on the ascertained workpiece blank by the order control device.

2. The computer-supported manufacturing method according to claim 1, wherein the manufacturing information includes a manufacturing end time for the defective workpiece to be remanufactured, wherein the workpiece blank is ascertained to be suitable if machining of the workpiece blank by the processing device in the manufacturing sequence takes place before the manufacturing end time.

3. The computer-supported manufacturing method according to claim 1, wherein the manufacturing information comprises a workpiece dimension, wherein the workpiece blank is ascertained to be suitable if the defective workpiece to be remanufactured is arranged on the workpiece blank.

4. The computer-supported manufacturing method according to claim 3, wherein planned workpieces to be manufactured are rearranged for the arrangement of the defective workpiece to be remanufactured on the ascertained workpiece blank.

5. The computer-supported manufacturing method according to claim 4, wherein, to arrange the defective workpiece to be remanufactured on the workpiece blank, planned workpieces to be manufactured are arranged on a workpiece blank following the workpiece blank.

6. The computer-supported manufacturing method according to claim 1, wherein the defective workpiece to be remanufactured arranged on the ascertaining workpiece blank is manufactured by the processing device.

7. The computer-supported manufacturing method according to claim 1, wherein the machine tool is designed as a laser cutting machine.

8. A manufacturing system comprising at least one processing device and the order control device, which is configured to perform the manufacturing method according to claim 1.

9. The computer-supported manufacturing method according to claim 1, wherein the machine tool is a flat-bed tool.

10. The computer-supported manufacturing method according to claim 3, wherein the defective workpiece to be remanufactured is arranged on the workspace blank in a free space between planned workpieces to be manufactured.
